(19) United States
(12) Patent Application Publication
(10) Pub. No.: US 2017/0009066 A1
(43) Pub. Date: Jan. 12, 2017

(54) RUBBER COMPOSITION AND PNEUMATIC TIRE

(71) Applicant: Toyo Tire & Rubber Co., Ltd., Osaka-shi, Osaka (JP)

(72) Inventors: Satoshi Fukunishi, Osaka-shi (JP); Takashi Yuri, Osaka-shi (JP)

(73) Assignee: Toyo Tire & Rubber Co., Ltd., Osaka-shi, Osaka (JP)

(21) Appl. No.: 15/301,260

(22) PCT Filed: Apr. 2, 2015
(86) PCT No.: PCT/JP2015/001893

§ 371 Date: Sep. 30, 2016

(30) Foreign Application Priority Data
Apr. 8, 2014 (JP) 2014-079626
Mar. 13, 2015 (JP) 2015-051049

(51) Int. Cl. C08L 9/06

(52) U.S. Cl. CPC C08L 9/06

(57) ABSTRACT

A rubber composition contains 100 parts by mass of a rubber component comprising diene rubber, and from 1 to 100 parts by mass of a (meth)acrylate polymer having a weight average molecular weight of from 5,000 to 1,000,000 and a glass transition point of from −70 to 0° C. A pneumatic tire is obtained using the rubber composition.

### TECHNICAL FIELD

The present invention relates to a rubber composition and a pneumatic tire using the same.

### BACKGROUND ART

Conventionally, for example, it is required in a rubber composition used in a tire to balance grip performance on a wet road surface (wet grip performance) and rolling resistance performance contributing to low fuel consumption in high dimension. However, those performances are conflicting characteristics, and it is not easy to simultaneously improve those characteristics.

Patent Document 1 proposes to add a copolymer resin of a C5 fraction by pyrolysis of naphtha and styrene or vinyltoluene in order to improve wet grip performance without deteriorating rolling resistance performance. In this case, wet grip performance can be improved, but improvement still remains in the characteristic.

Patent Document 2 proposes to add a high softening point resin comprising a C9 resin containing indene. In this case, grip performance is excellent, but rolling resistance performance is deteriorated, and good balance between wet grip performance and rolling resistance performance is not obtained. Furthermore, the rubber composition becomes hard at low temperature. Therefore, grip performance is deteriorated, and the problem remains in low temperature performance.

Patent Document 3 proposes to add a (meth)acrylate polymer having high glass transition point of 70° C. or higher and relatively high molecular weight in order to improve dry performance, wet performance and low fuel consumption. In this case, the balance between wet grip performance and rolling resistance performance is improved by the addition of a (meth)acrylate polymer having high glass transition point. However, grip performance is deteriorated by that a rubber composition becomes hard at low temperature, and there is the problem that low temperature performance is decreased.

Patent Document 4 discloses that a (meth)acrylate polymer having a reactive silyl group at the end and having a weight average molecular weight of from 500 to 100,000 is added together with silica and a silane coupling agent to diene rubber. However, in this patent document, the (meth)acrylate polymer reacts with silica by having a reactive silyl group at the end, thereby improving dispersibility of silica and contributing to the improvement of rolling resistance performance. This patent document does not disclose that wet grip performance can be improved while suppressing the deterioration of low temperature performance and rolling resistance performance, by adding a (meth)acrylate polymer having high molecular weight and low glass transition point.

### PRIOR ART DOCUMENTS

### Patent Document

Patent Document 1: JP-A-09-328577

Patent Document 2: JP-A-2008-169295

Patent Document 3: JP-A-2006-274049

Patent Document 4: JP-A-2013-133436

### SUMMARY OF THE INVENTION

### Problems that the Invention is to Solve

The embodiment of the present invention has an object to provide a rubber composition that can improve wet grip performance while suppressing the deterioration of low temperature performance and rolling resistance performance.

### Means for Solving the Problems

The rubber composition according to the embodiment contains 100 parts by mass of a rubber component comprising diene rubber, and from 1 to 100 parts by mass of a (meth)acrylate polymer having a weight average molecular weight of from 5,000 to 1,000,000 and a glass transition point of from −70 to 0° C.

A pneumatic tire according to the embodiment uses the rubber composition.

### Advantageous Effects of the Invention

According to the present embodiment, by adding the above-described specific (meth)acrylate polymer to diene rubber, wet grip performance can be improved while suppressing the deterioration of low temperature performance and rolling resistance performance.

### MODE FOR CARRYING OUT THE INVENTION

The rubber composition according to the present embodiment is a rubber composition comprising a rubber component comprising diene rubber, and added thereto, a (meth)acrylate polymer having a weight average molecular weight of from 5,000 to 1,000,000 and a glass transition point of from −70 to 0° C. Thus, by adding a (meth)acrylate polymer having high molecular weight and low glass transition point to diene rubber, viscoelasticity of a rubber composition is changed, and excellent wet grip performance can be developed while suppressing the deterioration of rolling resistance performance. Additionally, the increase of elastic modulus at low temperature is suppressed, thereby the deterioration of low temperature performance can be suppressed.

Examples of the diene rubber as the rubber component include natural rubber (NR), synthetic isoprene rubber (IR), butadiene rubber (BR), styrene-butadiene rubber (SBR), nitrile rubber (NBR), chloroprene rubber (CR), butyl rubber (IR), styrene-isoprene copolymer rubber, butadiene-isoprene copolymer rubber, and styrene-isoprene-butadiene copolymer rubber. Those can be used in any one kind alone or as mixtures of two or more kinds thereof. Of those, at least one kind selected from the group consisting of NR, BR and SBR is preferred.

The (meth)acrylate polymer is a polymer containing one or more kind of (meth)acrylate units. That is, it is a homopolymer or a copolymer, obtained by polymerizing a monomer containing one kind or two or more kinds of (meth)acrylates. The (meth)acrylate used herein means one or both of acrylate and methacrylate. Furthermore, (meth)acrylic acid means one or both of acrylic acid and methacrylic acid.

The (meth)acrylate polymer used has a weight average molecular weight (Mw) of 5,000 or more. When the weight average molecular weight (Mw) is 5,000 (g/mol) or more, the improvement effect of wet grip performance can be enhanced. The upper limit of the weight average molecular weight is not particularly limited, but is generally 1,000,000 (g/mol) or less. The weight average molecular weight of the (meth)acrylate polymer is preferably from 10,000 to 500,000, more preferably from 30,000 to 500,000, still more preferably from 50,000 to 500,000, and particularly preferably from 120,000 to 400,000.

The (meth)acrylate polymer used has low glass transition point (Tg) such that Tg is from −70 to 0° C. When the glass transition point of the (meth)acrylate polymer having the above-described weight average molecular weight is 0° C. or lower, the deterioration of low temperature performance can be suppressed while developing the improvement effect of wet grip performance. Furthermore, when the glass transition point is −70° C. or higher, the improvement effect of wet grip performance can be developed. The glass transition point of the (meth)acrylate polymer is preferably from −70 to −20° C., and more preferably from −60 to −30° C.

The (meth)acrylate polymer is preferably an alkyl (meth)acrylate polymer (homopolymer or copolymer) having a repeating unit (that is, an alkyl (meth)acrylate unit) represented by the following general formula (1):

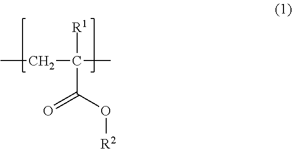

In the general formula (1), R¹ is a hydrogen atom or a methyl group, and R¹ present in the same molecule may be the same or different. R² is an alkyl group having from 4 to 18 carbon atoms, and R² present in the same molecule may be the same or different. The alkyl group of R² may be a straight chain or may be a branched chain. R² is preferably an alkyl group having from 6 to 16 carbon atoms, and more preferably an alkyl group having from 8 to 12 carbon atoms.

Examples of (meth)acrylate constituting the (meth)acrylate polymer include n-alkyl (meth)acrylate such as n-butyl acrylate, n-pentyl acrylate, n-hexyl acrylate, n-heptyl acrylate, n-octyl acrylate, n-nonyl acrylate, n-decyl acrylate, n-undecyl acrylate, n-dodecyl acrylate, n-tridecyl acrylate, n-butyl methacrylate, n-pentyl methacrylate, n-hexyl methacrylate, n-heptyl methacrylate, n-octyl methacrylate, n-nonyl methacrylate, n-decyl methacrylate, n-undecyl methacrylate and n-dodecyl methacrylate; isoalkyl (meth)acrylate such as isobutyl acrylate, isopentyl acrylate, isohexyl acrylate, isoheptyl acrylate, isooctyl acrylate, isononyl acrylate, isodecyl acrylate, isoundecyl acrylate, isododecyl acrylate, isotridecyl acrylate, isotetradecyl acrylate, isobutyl methacrylate, isopentyl methacrylate, isohexyl methacrylate, isoheptyl methacrylate, isooctyl methacrylate, isononyl methacrylate, isodecyl methacrylate, isoundecyl methacrylate, isododecyl methacrylate, isotridecyl methacrylate and isotetradecyl methacrylate; 2-methylbutyl acrylate, 2-ethylpentyl acrylate, 2-methylhexyl acrylate, 2-ethylhexyl acrylate, 2-ethylheptyl acrylate, 2-methylpentyl methacrylate, 2-methylhexyl methacrylate, 2-ethylhexyl methacrylate and 2-ethylheptyl methacrylate. Those can be used in any one kind alone or as mixtures of two or more kinds thereof.

Of those, isodecyl methacrylate and n-dodecyl methacrylate are exemplified as preferred examples of the (meth)acrylate, and isodecyl methacrylate is exemplified as more preferred example. Therefore, the (meth)acrylate polymer according to one embodiment may be preferably a polymer of a monomer containing at least one kind selected from the group consisting of isodecyl methacrylate and n-dodecyl methacrylate, and may be more preferably a polymer of a monomer containing isodecyl methacrylate.

The isoalkyl used herein means an alkyl group having a methyl side chain in the second carbon atom from an alkyl chain end. For example, isodecyl means an alkyl group of 10 carbon atoms having a methyl side chain in the second carbon atom from a chain end, and is a concept including not only 8-methylnonyl group, but 2,4,6-trimethylheptyl group in the formula (7) mentioned hereinafter.

In a certain embodiment, the (meth)acrylate polymer may be a homopolymer or a copolymer, having a repeating unit represented by the general formula (1) in which R² is represented by the following general formula (2). That is, the alkyl (meth)acrylate polymer according to the embodiment has a repeating unit represented by the following general formula (2A).

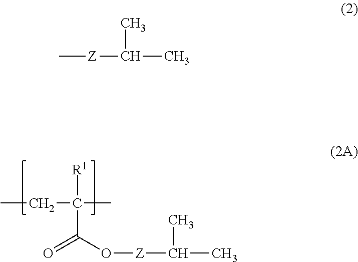

In the formulae (2) and (2A), Z is an alkylene group having from 1 to 15 carbon atoms, and Z in the same molecule may be the same or different. Z may be a straight chain or may be a branched chain. R¹ is a hydrogen atom or a methyl group (preferably a methyl group), and R¹ in the same molecule may be the same or different.

Example of the (meth)acrylate constituting the (meth)acrylate polymer like this includes the above-described isoalkyl (meth)acrylate. Further effect that the decrease of hardness at room temperature is suppressed is developed by using the (meth)acrylate (more preferably methacrylate) having the isoalkyl group. Z in the formulae (2) and (2A) is preferably an alkylene group having from 5 to 15 carbon atoms, and more preferably an alkylene group having from 7 to 11 carbon atoms, and this is advantageous in exhibiting the effect that the balance between wet grip performance and rolling resistance performance is improved while suppressing the decrease of room temperature hardness and the increase of low temperature elastic modulus.

In other embodiment, the (meth)acrylate polymer may be a copolymer having a repeating unit represented by the general formula (1) in which R² is represented by the general formula (2) and a repeating unit represented by the general formula (1) in which R² is represented by the following general formula (3). That is, the alkyl (meth)acrylate polymer according to this embodiment has a repeating unit represented by the general formula (2A) and a repeating unit represented by the following general formula (3A). Addition form of those repeating units may be random addition and may be block addition. Random addition is preferred.

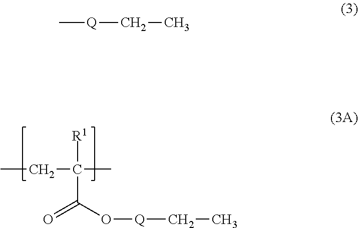

In the formulae (3) and (3A), Q is an alkylene group having from 2 to 16 carbon atoms, and Q in the same molecule may be the same or different. Q may be a straight chain or may be a branched chain. R¹ is a hydrogen atom or a methyl group (preferably a methyl group), and R¹ in the same molecule may be the same or different.

When the (meth)acrylate polymer is the copolymer as described above, the effect that the balance between wet grip performance and rolling resistance performance is improved while suppressing the decrease of room temperature hardness and the increase of low temperature elastic modulus can be enhanced.

Specific examples of the (meth)acrylate constituting the repeating unit represented by the formula (3A) include the above-exemplified (meth)acrylates excluding isoalkyl (meth)acrylate. Q in the formula (3) and the formula (3A) is preferably an alkylene group having from 2 to 10 carbon atoms, and more preferably a branched alkylene group having from 4 to 8 carbon atoms. As the preferred embodiment of R² represented by the general formula (3). R² may be a group represented by the following general formula (3B).

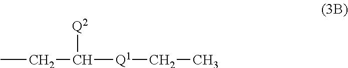

In the formula (3B), Q¹ is an alkylene group having from 1 to 6 (preferably from 1 to 3) carbon atoms, and may be a straight chain or may be a branched chain (preferably a straight chain). Q² is a methyl group or an ethyl group.

In the case of the copolymer, the proportions (copolymerization ratio) of the repeating unit represented by the formula (2A) and the repeating unit represented by the formula (3A) are not particularly limited. For example, when the total repeating unit of a vinyl polymer chain constituting the (meth)acrylate polymer is 100 mol %, the proportion of the repeating unit of the formula (2A) may be 30 mol % or more and less than 100 mol % and the proportion of the repeating unit of the formula (3A) may be more than 0 mol % and 70 mol % or less; and the proportion of the repeating unit of the formula (2A) may be from 40 to 90 mol % and the proportion of the repeating unit of the formula (3A) may be from 10 to 60 mol %.

The monomer constituting the (meth)acrylate polymer according to the present embodiment basically comprises (meth)acrylate, that is, comprises the above-described (meth)acrylate as a main component, but other vinyl compound may be used together in a range that does not impair the effect. Although not particularly limited, it is preferred that the content of the (meth)acrylate unit (preferably an alkyl (meth)acrylate unit of the formula (1)) to the entire repeating units of the vinyl polymer chain constituting the (meth)acrylate polymer is 90 mol % or more. Furthermore, in one embodiment, the (meth)acrylate polymer may be that the content of the repeating unit of the formula (2A) to the entire repeating units is 30 mol % or more (preferably 40 mol % or more) and the total of the content of the repeating unit of the formula (2A) and the content of other (meth)acrylate unit (preferably, the repeating unit of the formula (1) excluding the repeating unit of the formula (2A)) is 90 mol % or more.

The (meth)acrylate polymer used in the present embodiment is not used as a dispersing agent for silica, and therefore does not have a reactive group bonding to silica. Therefore, the (meth)acrylate polymer is a (meth)acrylate polymer that does not have a reactive silyl group at the end thereof.

The (meth)acrylate polymer includes, for example, each embodiment of the following [x], [y] and [z], and those may be used in any one kind alone or as combinations of two or more kinds thereof.

The (meth)acrylate polymer [x] is a polymer having an end structure represented by the following general formula (4). That is, the (meth)acrylate polymer [x] has a structure in which a group represented by the formula (4) is directly bonded to the end of a vinyl polymer chain obtained by polymerizing a monomer comprising the (meth)acrylate. The end structure represented by the formula (4) may be present at both ends of the (meth)acrylate polymer and may be present at one end thereof.

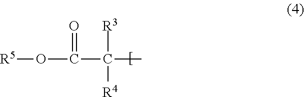

In the formula (4), R³ and R⁴ each independently are a hydrogen atom or an alkyl group having from 1 to 3 carbon atoms, but are not simultaneously a hydrogen atom. R³ and R⁴ each independently are preferably a methyl group or an ethyl group, and are more preferably a methyl group simultaneously. R⁵ is a saturated or unsaturated alkyl group having from 2 to 20 carbon atoms. The saturated or unsaturated alkyl group may be a straight chain and may be a branched chain. Therefore, in detail, R⁵ is a straight-chain saturated or unsaturated alkyl group having from 2 to 20 carbon atoms or a branched saturated or unsaturated alkyl group having from 3 to 20 carbon atoms. The number of an unsaturated bond in the unsaturated alkyl group is not limited to 1, and may be 2 or more. More preferably, R⁵ is an alkyl group or an alkenyl group, having from 2 to 18 carbon atoms, and examples thereof include ethyl group, propyl group, isopropyl group, butyl group, isobutyl group, t-butyl group, s-butyl group, pentyl group, hexyl group, heptyl group, octyl group, nonyl group, undecyl group, dodecyl group, tridecyl group, tetradecyl group, pentadecyl group, hexadecyl group, heptadecyl group, octadecyl group, nonadecyl group, icosyl group, vinyl group, allyl group, butenyl group, pentenyl group, hexenyl group, heptenyl group, octenyl group, nonenyl group, decenyl group, undecenyl group, dodecenyl group, tridecenyl group, tetradecenyl group, pentadecenyl group, hexadecenyl group, heptadecenyl group, octadecenyl group, nonadecenyl group and icosenyl group.

The (meth)acrylate polymer [x] can be obtained by, for example, polymerizing the (meth)acrylate using a radical polymerization initiator represented by the following general formula (5).

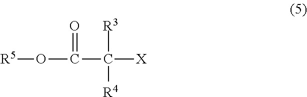

In the formula (5). R³, R⁴ and R⁵ are the same as in the formula (4). X is a halogen atom, and examples thereof include a chlorine atom, a bromine atom and an iodine atom. Of those, a bromine atom is preferred. The radical polymerization initiator is an initiator having an α-haloester group and living radical polymerization initiating ability by atom transfer radical polymerization (ATRP). Radicals are generated in the presence of a transition metal complex, and polymerization reaction proceeds. The transition metal complex as a catalyst is preferably a metal complex comprising Group 7, Group 8, Group 9, Group 10 or Group 11 element of a periodic table as a central metal, and more preferably a zerovalent copper, monovalent copper, divalent ruthenium, divalent iron or divalent nickel complex. Particularly a monovalent copper complex is preferred, and a copper (I) complex having amine/imine multidentate ligand, for example, a copper halide (for example, copper chloride or copper bromide)/amine complex is preferably used.

The (meth)acrylate [x] thus obtained has the structure that one end of a vinyl polymer chain containing the repeating unit represented by the formula (1) has the group represented by the formula (4) and other end thereof has a halogen atom, and is represented by the following general formula (6) as one embodiment.

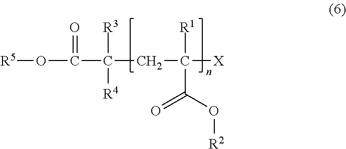

In the formula (6), R¹, R², R³, R⁴, R⁵ and X are the same as in the formula (1), the formula (4) and the formula (5), and n is a repeating number of the repeating unit of the formula (1) and is an integer of 1 or more. The (meth)acrylate polymer [x] having the halogen end may be added in such a form to a rubber composition, and/or the halogen end may be substituted with other structure and such a polymer may be used.

The (meth)acrylate polymer [y] is synthesized by radical polymerization using an initiator comprising an azo compound. Examples of the azo compound as a radical polymerization initiator include 2,2′-azobisisobutyronitrile (AIBN), 1,1′-azobis(cyclohexanecarbonitrile) (ABCN), 2,2′-azobis(2,4,4-trimethylpentane), 2,2′-azobis(2-methylpropane), 2,2′-azobis(2-methylbutyronitrile), 2,2′-azobis(2,4-dimethylvaleronitrile), 2,2′-azobis(4-methoxy-2,4-dimethylvaleronitrile), 2,2′-azobis(4-methoxy-2,4-dimethylvaleronitrile and 2,2′-azobis[N-(2-propenyl)-2-methylpropionamide].

When radical polymerization is conducted using the initiator comprising an azo compound, a (meth)acrylate polymer having a residual group derived from the azo compound at one end is obtained. Regarding other end, when a termination reaction is recombination, a (meth)acrylate polymer having a residue derived from the azo compound is obtained, and when a termination reaction is disproportionation, a (meth)acrylate polymer having a saturated bond at the end and a (meth)acrylate polymer having an unsaturated bond at the end are obtained. For example, in the case of AIBN, a (meth)acrylate polymer having a (CH₃)₂(NC)C— at one end is obtained.

The (meth)acrylate polymer [z] is a star polymer synthesized using a polyfunctional initiator. That is, the (meth)acrylate polymer [z] is a multibranched polymer having a structure in which an arm part comprising a vinyl polymer chain containing a (meth)acrylate unit has been extended from a core part derived from the polyfunctional initiator by an atom transfer radical polymerization method.

The polyfunctional initiator is a compound having a plurality (preferably 3 or more) of functional groups having living radical polymerization initiating ability, and examples thereof include hexafunctional dipentaerythritolhexakis(2-bromoisobutyrate), tetrafunctional pentaerythritoltetrakis(2-bromoisobutyrate), and trifunctional 1,1,1-tris(2-bromoisobutyloxymethylene)ethane.

In the rubber composition according to the present embodiment, the amount of the (meth)acrylate polymer added can be from 1 to 100 parts by mass per 100 parts by mass of the rubber component comprising diene rubber, and is more preferably from 2 to 50 parts by mass, and still more preferably from 3 to 30 parts by mass.

The rubber composition according to the present embodiment can contain various additives generally used in a rubber composition, such as a reinforcing filler, a silane coupling agent, oil, zinc flower, stearic acid, an age resister, a wax, a vulcanizing agent and a vulcanization accelerator, in addition to the (meth)acrylate polymer.

As the reinforcing filler, silica such as wet silica (hydrous silicic acid), or carbon black is preferably used. More preferably, silica is used in order to improve the balance between rolling resistance performance and wet grip performance. Use of silica alone or combined use of silica and carbon black is preferred. The amount of the reinforcing filler added is not particularly limited, and, for example, may be form 20 to 150 parts by mass per 100 parts by mass of the rubber component. The amount is more preferably from 30 to 100 parts by mass. The amount of the silica added is not particularly limited, and, for example, may be form 20 to 150 parts by mass per 100 parts by mass of the rubber component. The amount is more preferably from 30 to 100 parts by mass.

When silica is added, it is preferred to use the silica together with a silane coupling agent. In such a case, the amount of the silane coupling agent added is preferably from 2 to 20 mass %, and more preferably from 4 to 15 mass %, based on the mass of silica.

Sulfur is preferably used as the vulcanizing agent. The amount of the vulcanizing agent added is not particularly limited, but is preferably from 0.1 to 10 parts by mass, and more preferably from 0.5 to 5 parts by mass, per 100 parts by mass of the rubber component. Examples of the vulcanization accelerator include various vulcanization accelerators such as a sulfenamide type, a thiuram type, a thiazole type or a guanidine type. Those can be used in any one kind alone or as mixtures of two or more kinds thereof. The amount of the vulcanization accelerator added is not particularly limited, but is preferably from 0.1 to 7 parts by mass, and more preferably from 0.5 to 5 parts by mass, per 100 parts by mass of the rubber component.

The rubber composition according to the present embodiment can be prepared by kneading the necessary components according to the conventional method using a mixing machine generally used, such as Banbury mixer, a kneader or rolls. Specifically, for example, other additives excluding a vulcanizing agent and a vulcanization accelerator are added to diene rubber together with a (meth)acrylate polymer, followed by mixing, in a first mixing step. A vulcanizing agent and a vulcanization accelerator are then added to the mixture thus obtained, followed by mixing, in a final mixing step. Thus, a rubber composition can be prepared.

The rubber composition thus obtained can be used in various rubber members for tires, vibration proof rubber, conveyer belts and the like. The rubber composition is preferably used in tires, and can be applied to various uses and sizes such as for passenger cars or for large-sized tires of trucks or buses, and each site of a tire, such as a tread part or a side wall part of pneumatic tires. That is, the rubber composition is formed into a predetermined shape according to the conventional method by, for example, extrusion, is combined with other parts, and is then vulcanization-molded at a temperature of, for example, from 140 to 180° C. Thus, a pneumatic tire can be produced. Of those, the rubber composition is particularly preferably used in the formulation for a tread of a tire.

### Examples

Examples are described below, but the present invention is not construed as being limited to those examples.

[Measurement Method of Mn, Mw and Mw/Mn]

Obtained in terms of polystyrene by measurement with gel permeation chromatography (GPC). In detail, 0.2 mg of a polymer was dissolved in 1 mL of THF, and this was used as a measurement sample. “LC-20DA” manufactured by Shimadzu Corporation was used. A sample was passed through a filter. Thereafter, the sample was passed through a column (“PL Gel 3 μm Guard×2” manufactured by Polymer Laboratories) in a flow rate of 0.7 mL/min at a temperature of 40° C. and detected with “RI Detector” manufactured by Spectra System.

[Measurement Method of Tg]

Measured in a temperature rising rate of 20° C./min (measurable temperature range: −150 to 50° C.) by a differential scanning calorimetry (DSC) according to JIS K7121

### Synthesis Example 1

### Synthesis of (Meth)acrylate Polymer

30 g of isodecyl methacrylate (that is, 2,4,6-trimethylheptyl methacrylate), 0.129 g of ethyl 2-bromoisobutyrate and 0.115 g of N,N,N′,N″,N″-pentamethyldiethylene triamine were mixed (vinyl monomer/initiator (molar ratio)=200), followed by bubbling with nitrogen for 1 hour. Thereafter, 0.190 g of copper (1) bromide was added to the resulting reaction solution, followed by maintaining at 70° C. for 5 hours. The solution obtained was subjected to reprecipitation purification in methanol, and a (meth)acrylate polymer according to Synthesis Example 1 (hereinafter referred to as polymer 1) was obtained. The polymer 1 is represented by the following formula (7) and has the structure of the formula (4) (R³═R⁴=methyl group. R⁵=ethyl group) at one end of a polyisodecyl methacrylate chain. The polymer 1 had a number average molecular weight (Mn) of 54,000, a weight average molecular weight (Mw) of 67,000, a molecular weight distribution (Mw/Mn) of 1.24, and a glass transition point (Tg) of −41° C.

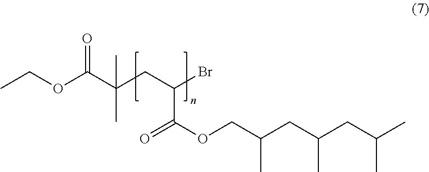

### Synthesis Example 2

### Synthesis of (Meth)acrylate Polymer

30 g of isodecyl methacrylate (that is, 2,4,6-trimethylheptyl methacrylate), 100 mL of toluene and 0.218 g of azobisisobutyronitrile were mixed (vinyl monomer/initiator (molar ratio)=100), followed by bubbling with nitrogen for 1 hour, and the reaction solution was then maintained at 60° C. for 8 hours. The solution obtained was subjected to reprecipitation purification in methanol, and a (meth)acrylate polymer according to Synthesis Example 2 (hereinafter referred to as polymer 2) was obtained. The polymer 2 had Mn of 100,000, Mw of 260,000, Mw/Mn of 2.60, and Tg of −40° C.

### Synthesis Example 3

### Synthesis of (Meth)acrylate Polymer

(Meth)acrylate polymer according to Synthesis Example 3 (hereinafter referred to as polymer 3) was obtained in the same manner as in Synthesis Example 1, except for using pentaerythritol hexakis(2-bromoisobutyrate) in place of ethyl 2-bromoisobutyrate used in the synthesis of the polymer 1 (vinyl monomer/polymerization initiating group in initiator (molar ratio)=200). The polymer 3 was a star polymer having a structure in which arm parts of 6 polyisodecyl methacrylate (that is, poly-2,4,6-trimethylheptyl methacrylate) chains were extended from a core part derived from a polyfunctional (hexafunctional) initiator, and had Mn of 270,000, Mw of 351,000, Mw/Mn of 1.30 and Tg of −40° C.

### Synthesis Example 4

### Synthesis of (Meth)acrylate Polymer

(Meth)acrylate polymer according to Synthesis Example 4 (hereinafter referred to as polymer 4) was obtained in the same manner as in Synthesis Example 1, except for using n-dodecyl methacrylate in place of isodecyl methacrylate used in the synthesis of the polymer 1 (vinyl monomer/initiator (molar ratio)=200). The polymer 4 had Mn of 61,000, Mw of 87,000, Mw/Mn of 1.45 and Tg of −65° C.

### Synthesis Example 5

### Synthesis of (Meth)acrylate Polymer

(Meth)acrylate polymer according to Synthesis Example 5 (hereinafter referred to as polymer 5) was obtained in the same manner as in Synthesis Example 1, except for using n-butyl acrylate in place of isodecyl methacrylate used in the synthesis of the polymer 1 (vinyl monomer/initiator (molar ratio)=200). The polymer 5 had Mn of 31,000, Mw of 39,000, Mw/Mn of 1.26 and Tg of −54° C.

### Synthesis Example 6

### Synthesis of (Meth)acrylate Polymer

(Meth)acrylate polymer according to Synthesis Example 6 (hereinafter referred to as polymer 6) was obtained in the same manner as in Synthesis Example 1, except that a molar ratio (vinyl monomer/initiator) between isodecyl methacrylate (vinyl monomer) and ethyl 2-bromoisobutyrate, used in the synthesis of the polymer 1 was 50. The polymer 6 had a number average molecular weight (Mn) of 12,000, a weight average molecular weight (Mw) of 15,000, a molecular weight distribution (Mw/Mn) of 1.25 and a glass transition point (Tg) of −42° C.

### Synthesis Example 7

### Synthesis of (Meth)acrylate Polymer

(Meth)acrylate polymer according to Synthesis Example 7 (hereinafter referred to as polymer 7) was obtained in the same manner as in Synthesis Example 2, except that azobis(4-methoxy-2,4-dimethylvaleronitrile was used in place of azobisisobutyronitrile used in the synthesis of the polymer 2 (vinyl monomer/initiator (molar ratio)=100) and a temperature of the reaction solution after bubbling with nitrogen was 30° C. The polymer 7 had Mn of 95,000, Mw of 250,000, Mw/Mn of 2.63 and Tg of −41° C.

### Synthesis Example 8

### Synthesis of (Meth)acrylate Polymer

(Meth)acrylate polymer according to Synthesis Example 8 (hereinafter referred to as polymer 8) was obtained in the same manner as in Synthesis Example 3, except for using 1,1,1-tris(2-bromoisobutyloxymethylene)ethane in place of pentaerithritol hexakis(2-bromoisobutyrate) used in the synthesis of the polymer 3 (vinyl monomer/polymerization initiating group in initiator (molar ratio)=200). The polymer 8 was a star polymer having a structure in which arm parts of 3 polyisodecyl methacrylate (that is, poly-2,4,6-trimethylheptyl methacrylate) chains were extended from a core part derived from a polyfunctional (trifunctional) initiator, and had Mn of 135,000, Mw of 170,000, Mw/Mn of 1.26 and Tg of −39° C.

### Synthesis Example 9

### Synthesis of (Meth)acrylate Polymer (Comparative Example)

(Meth)acrylate polymer according to Synthesis Example 9 (hereinafter referred to as polymer 9) was obtained in the same manner as in Synthesis Example 1, except for using t-butyl methacrylate in place of isodecyl methacrylate used in the synthesis of the polymer 1 (vinyl monomer/initiator (molar ratio)=200). The polymer 9 had Mn of 34,000, Mw of 42,000, Mw/Mn of 1.24 and Tg of 120° C.

### Synthesis Example 10

### Synthesis of (Meth)acrylate Polymer (Comparative Example)

(Meth)acrylate polymer according to Synthesis Example 10 (hereinafter referred to as polymer 10) was obtained in the same manner as in Synthesis Example 1, except that a molar ratio (vinyl monomer/initiator) between isodecyl methacrylate (vinyl monomer) and ethyl 2-bromoisobutyrate, used in the synthesis of the polymer 1 was 10. The polymer 10 had Mn of 2,700, Mw of 3,400, Mw/Mn of 1.26 and Tg of −50° C.

### Synthesis Example 11

### Synthesis of (Meth)acrylate Polymer (Comparative Example)

30 g of isodecyl methacrylate (that is, 2,4,6-trimethylheptyl methacrylate), 100 mL of toluene, 3.13 g of α-methylstyrene dimer and 0.218 g of azobisisobutyronitrile were mixed, followed by bubbling with nitrogen for 1 hour, and the reaction solution was then maintained at 60° C. for 8 hours. The solution obtained was subjected to reprecipitation purification in methanol, and a (meth)acrylate polymer according to Synthesis Example 11 (hereinafter referred to as polymer 11) was obtained. The polymer 11 had Mn of 2,500, Mw of 3,800, Mw/Mn of 1.52, and Tg of −50° C.

### Synthesis Example 12

### Synthesis of (Meth)acrylate Polymer

(Meth)acrylate polymer according to Synthesis Example 12 (hereinafter referred to as polymer 12) was obtained in the same manner as in Synthesis Example 2, except for using isodecyl acrylate (that is, 8-methylnonyl acrylate) in place of 2,4,6-trimethylheptyl methacrylate used in the synthesis of the polymer 2 (vinyl monomer/initiator (molar ratio)=100). The polymer 12 had Mn of 90,000, Mw of 230,000, Mw/Mn of 2.56 and Tg of −60° C.

### Synthesis Example 13

### Synthesis of (Meth)acrylate Polymer

(Meth)acrylate polymer according to Synthesis Example 13 (hereinafter referred to as polymer 13) was obtained in the same manner as in Synthesis Example 2, except for using 8-methylnonyl methacrylate in place of 2,4,6-trimethylheptyl methacrylate used in the synthesis of the polymer 2 (vinyl monomer/initiator (molar ratio)=100). The polymer 13 had Mn of 100,000, Mw of 260,000, Mw/Mn of 2.60 and Tg of −41° C.

### Synthesis Example 14

### Synthesis of (Meth)acrylate Polymer

(Meth)acrylate polymer according to Synthesis Example 14 (hereinafter referred to as polymer 14) was obtained in the same manner as in Synthesis Example 2, except for using 10-methylundecyl methacrylate in place of 2,4,6-trimethylheptyl methacrylate used in the synthesis of the polymer 2 (vinyl monomer/initiator (molar ratio)=100). The polymer 14 had Mn of 98,000, Mw of 240,000, Mw/Mn of 2.45 and Tg of −43° C.

### Synthesis Example 15

### Synthesis of (Meth)acrylate Polymer

(Meth)acrylate polymer according to Synthesis Example 15 (hereinafter referred to as polymer 15) was obtained in the same manner as in Synthesis Example 2, except for using 12-methyltridecyl methacrylate in place of 2,4,6-trimethylheptyl methacrylate used in the synthesis of the polymer 2 (vinyl monomer/initiator (molar ratio)=100). The polymer 15 had Mn of 99,000, Mw of 250,000, Mw/Mn of 2.53 and Tg of −46° C.

### Synthesis Example 16

### Synthesis of (Meth)acrylate Polymer

25 g of 2,4,6-trimethylheptyl methacrylate, 5.48 g of n-octyl methacrylate, 100 mL of toluene and 0.227 g of azobisisobutyronitrile were mixed (2,4,6-trimethylheptyl methacrylate:n-octyl methacrylate (molar ratio)=80:20, vinyl monomer/initiator (molar ratio)=100), followed by bubbling with nitrogen for 1 hour, and the reaction solution was then maintained at 60° C. for 8 hours. The solution obtained was subjected to reprecipitation purification in methanol, and a (meth)acrylate polymer according to Synthesis Example 16 (hereinafter referred to as polymer 16) was obtained. The polymer 16 had Mn of 110,000, Mw of 260,000, Mw/Mn of 2.36, and Tg of −35° C.

### Synthesis Example 17

### Synthesis of (Meth)acrylate Polymer

25 g of 2,4,6-trimethylheptyl methacrylate, 5.48 g of 2-ethylhexyl methacrylate, 100 mL of toluene and 0.227 g of azobisisobutyronitrile were mixed (2,4,6-trimethylheptyl methacrylate:2-ethylhexyl methacrylate (molar ratio)=80:20, vinyl monomer/initiator (molar ratio)=100), followed by bubbling with nitrogen for 1 hour, and the reaction solution was then maintained at 60° C. for 8 hours. The solution obtained was subjected to reprecipitation purification in methanol, and a (meth)acrylate polymer according to Synthesis Example 17 (hereinafter referred to as polymer 17) was obtained. The polymer 17 had Mn of 100,000, Mw of 250,000, Mw/Mn of 2.50, and Tg of −30° C.

### Synthesis Example 18

### Synthesis of (Meth)acrylate Polymer

(Meth)acrylate polymer according to Synthesis Example 18 (hereinafter referred to as polymer 18) was obtained in the same manner as in Synthesis Example 17, except that a molar ratio of 2,4,6-trimethylheptyl methacrylate and 2-ethylhexyl methacrylate, used in the synthesis of the polymer 17 was 50:50. The polymer 18 had Mn of 100,000, Mw of 250,000, Mw/Mn of 2.50, and Tg of −17° C.

### Synthesis Example 19

### Synthesis of (Meth)acrylate Polymer

(Meth)acrylate polymer according to Synthesis Example 19 (hereinafter referred to as polymer 19) was obtained in the same manner as in Synthesis Example 17, except that a molar ratio of 2,4,6-trimethylheptyl methacrylate and 2-ethylhexyl methacrylate, used in the synthesis of the polymer 17 was 30:70. The polymer 19 had Mn of 100,000, Mw of 260,000, Mw/Mn of 2.60, and Tg of −13° C.

[Evaluation of Rubber Composition]

Labo mixer (laboplast mill) was used. According to the formulations (parts by mass) shown in Tables 1 and 2 below, compounding ingredients excluding sulfur and a vulcanization accelerator were added to a diene rubber component, followed by kneading, in a first mixing step (discharge temperature: 160° C.). Sulfur and a vulcanization accelerator were then added to the kneaded product obtained, followed by kneading, in a final mixing step (discharge temperature: 90° C.). Thus, a rubber composition was prepared. The details of each component in Tables 1 and 2 are as follows.

SBR: “VSL5025” manufactured by LANXESS

BR: “UBEPOL BR150B” manufactured by Ube Industries, Ltd.

Silica: “NIPSIL AQ” manufactured by Tosoh Silica Corporation

Silane coupling agent: Bis(3-triethoxysilylpropyl)tetrasulfide, “Si69” manufactured by Evonik Degussa

Zinc flower: “Zinc Flower #1” manufactured by Mitsui Mining & Smelting Co., Ltd.

Age resister: “NOCRAC 6C” manufactured by Ouchi Shinko Chemical Industrial Co., Ltd.

Stearic acid: “LUNAC S-20” manufactured by Kao Corporation

Sulfur: “Powder Sulfur for Rubber 150 mesh” manufactured by Hosoi Chemical Industry Co., Ltd.

Vulcanization accelerator: “NOCCELER CZ” manufactured by Ouchi Shinko Chemical Industrial Co., Ltd.

Secondary vulcanization accelerator: “NOCCELER D” manufactured by Ouchi Shinko Chemical Industrial Co., Ltd.

Polymers 1 to 19: Synthesized in Synthesis Examples 1 to 19 above

Resin 1: Aromatic aliphatic copolymer type petroleum resin “PETROTACK 100” manufactured by Tosoh Corporation

Each rubber composition obtained was vulcanized at 160° C. for 20 minutes to prepare a test piece having a given shape. Using the test piece obtained, dynamic viscoelasticity test was conducted, and tan δ at 0° C. and 60° C. and storage modulus at −10° C. were measured. Additionally, hardness at room temperature (23° C.) was measured. The measurement method is as follows.

0° C. tan δ: Loss factor tan δ was measured under the conditions of frequency: 10 Hz, static strain: 10%, dynamic strain: 2% and temperature: 0° C. using Rheospectrometer E4000 manufactured by UBM, and was indicated by an index as the value of Comparative Example 1 being 100. Tan δ is large and wet grip performance is excellent, as the index is large.

60° C. tan δ: Loss factor tan δ was measured in the same manner as in 0° C. tan δ, except for changing the temperature to 60° C., and was indicated by an index as the value of Comparative Example 1 being 100. Heat generation is difficult to occur, rolling resistance of a tire is small and rolling resistance performance (that is, low fuel consumption) is excellent, as the index is small.

−10° C. Storage modulus E′: Storage modulus E′ at −10° C. was measured under the same conditions as in 0PC tan δ, except for changing the temperature to −10° C., and was indicated by an index as the value of Comparative Example 1 being 100. E′ is small and low temperature performance is excellent, as the index is small.

23° C. Hardness: Hardness at a temperature of 23° C. was measured with durometer type A according to JIS K6253, and was indicated by an index as the value of Comparative Example 1 being 100. Hardness at room temperature is high as the index is large.

TABLE 1

| Formulation | Com. | | | | | | | | | Com. | Com. | Com. | Com. |
|---|---|---|---|---|---|---|---|---|---|---|---|---|---|
| (parts by mass) | Ex. 1 | Ex. 1 | Ex. 2 | Ex. 3 | Ex. 4 | Ex. 5 | Ex 6 | Ex. 7 | Ex. 8 | Ex. 2 | Ex. 3 | Ex. 4 | Ex. 6 |
| SBR | 70 | 70 | 70 | 70 | 70 | 70 | 70 | 70 | 70 | 70 | 70 | 70 | 70 |
| BR | 30 | 30 | 30 | 30 | 30 | 30 | 30 | 30 | 30 | 30 | 30 | 30 | 30 |
| Silica | 70 | 70 | 70 | 70 | 70 | 70 | 70 | 70 | 70 | 70 | 70 | 70 | 70 |
| Silane coupling agent | 5.6 | 5.6 | 5.6 | 5.6 | 5.6 | 5.6 | 5.6 | 5.6 | 5.6 | 5.6 | 5.6 | 5.6 | 5.6 |
| Polymer 1 | | 10 | | | | | | | | | | | |
| Polymer 2 | | | 10 | | | | | | | | | | |
| Polymer 3 | | | | 10 | | | | | | | | | |
| Polymer 4 | | | | | 10 | | | | | | | | |
| Polymer 5 | | | | | | 10 | | | | | | | |
| Polymer 6 | | | | | | | 10 | | | | | | |
| Polymer 7 | | | | | | | | 10 | | | | | |
| Polymer 8 | | | | | | | | | 10 | | | | |
| Polymer 9 | | | | | | | | | | 10 | | | |
| Polymer 10 | | | | | | | | | | | 10 | | |
| Polymer 11 | | | | | | | | | | | | 10 | |
| Resin 1 | | | | | | | | | | | | | 10 |
| Zinc flower | 2 | 2 | 2 | 2 | 2 | 2 | 2 | 2 | 2 | 2 | 2 | 2 | 2 |
| Age resister | 2 | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 | 2 |
| Sulfur | 1.8 | 1.8 | 1.8 | 1.8 | 1.8 | 1.8 | 1.8 | 1.8 | 1.8 | 1.8 | 1.8 | 1.8 | 1.8 |
| Vulcanization accelerator | 1.8 | 1.8 | 1.8 | 1.8 | 1.8 | 1.8 | 1.8 | 1.8 | 1.8 | 1.8 | 1.8 | 1.8 | 1.8 |
| Secondary vulcanization | 1.5 | 1.5 | 1.5 | 1.5 | 1.5 | 1.5 | 1.5 | 1.5 | 1.5 | 1.5 | 1.5 | 1.5 | 1.5 |
| accelerator | | | | | | | | | | | | | |
| Property (index) | | | | | | | | | | | | | |
| 0° C. tan δ | 100 | 126 | 129 | 136 | 121 | 124 | 121 | 131 | 129 | 119 | 100 | 103 | 110 |
| 60° C. tan δ | 100 | 101 | 100 | 102 | 100 | 101 | 101 | 103 | 102 | 105 | 102 | 103 | 105 |
| −10° C. E′ | 100 | 104 | 102 | 102 | 98 | 101 | 97 | 102 | 100 | 136 | 105 | 104 | 139 |
| 23° C. Hardness | 100 | 98 | 98 | 98 | 95 | 93 | 98 | 98 | 98 | 102 | 86 | 87 | 92 |

TABLE 2

| Formulation | | | | | | | | |
|---|---|---|---|---|---|---|---|---|
| (parts by mass) | Ex. 9 | Ex. 10 | Ex. 11 | Ex. 12 | Ex. 13 | Ex. 14 | Ex. 15 | Ex. 16 |
| SBR | 70 | 70 | 70 | 70 | 70 | 70 | 70 | 70 |
| BR | 30 | 30 | 30 | 30 | 30 | 30 | 30 | 30 |
| Silica | 70 | 70 | 70 | 70 | 70 | 70 | 70 | 70 |
| Silane coupling agent | 5.6 | 5.6 | 5.6 | 5.6 | 5.6 | 5.6 | 5.6 | 5.6 |
| Polymer 12 | 10 | | | | | | | |
| Polymer 13 | | 10 | | | | | | |
| Polymer 14 | | | 10 | | | | | |
| Polymer 15 | | | | 10 | | | | |
| Polymer 16 | | | | | 10 | | | |
| Polymer 17 | | | | | | 10 | | |
| Polymer 18 | | | | | | | 10 | |
| Polymer 19 | | | | | | | | 10 |
| Zinc flower | 2 | 2 | 2 | 2 | 2 | 2 | 2 | 2 |
| Age resister | 2 | 2 | 2 | 2 | 2 | 2 | 2 | 2 |
| Stearic acid | 2 | 9 | 2 | 2 | 2 | 2 | 2 | 2 |
| Sulfur | 1.8 | 1.8 | 1.8 | 1.8 | 1.8 | 1.8 | 1.8 | 1.8 |
| Vulcanization accelerator | 1.8 | 1.8 | 1.8 | 1.8 | 1.8 | 1.8 | 1.8 | 1.8 |
| Secondary vulcanization | 1.5 | 1.5 | 1.5 | 1.5 | 1.5 | 1.5 | 1.5 | 1.5 |
| accelerator | | | | | | | | |
| Property (index) | | | | | | | | |
| 0° C. tan δ | 127 | 128 | 125 | 126 | 132 | 135 | 139 | 140 |
| 60° C. tan δ | 100 | 100 | 100 | 102 | 101 | 101 | 103 | 104 |
| −10° C. E′ | 100 | 101 | 101 | 101 | 103 | 103 | 105 | 109 |
| 23° C. Hardness | 97 | 98 | 98 | 98 | 99 | 100 | 102 | 102 |

The results are shown in Tables 1 and 2. As compared with Comparative Example 1 as a control in Examples 1 to 16 in which the polymers 1 to 8 and 12 to 19 as the above-described specific (meth)acrylate polymers were added, wet grip performance was remarkably improved without substantially deteriorating rolling resistance performance. Furthermore, elastic modulus at low temperature was not greatly increased, and low temperature performance was excellent. On the other hand, in Comparative Example 2 in which a (meth)acrylate polymer having high glass transition point was used and Comparative Example 5 in which an aromatic-aliphatic copolymer type petroleum resin was added, wet grip performance was improved, but low temperature performance was deteriorated. Those Comparative Examples were unsatisfactory in the balance of those. Furthermore, in Comparative Examples 3 and 4 in which a (meth)acrylate polymer having small molecular weight was added, the improvement effect of wet grip performance was not obtained. Furthermore, in Comparative Examples 3, 4 and 5, the decrease of hardness at room temperature was appeared, and the decrease of driving stability was concerned.

Of Examples 1 to 16, in Examples 4 and 5 in which straight-chain (meth)acrylate was used, hardness at room temperature tends to decrease, and particularly, the tendency was great in an acrylate type rather than a methacrylate type. On the other hand, in Examples 1 to 3 and 6 to 16 in which (meth)acrylate having an isoalkyl group was used, the decrease of hardness at room temperature was suppressed. Of the Examples using (meth)acrylate having an isoalkyl group, as compared with Example 9 that is an acrylate type, other Examples that are a methacrylate type were excellent in the suppression effect of the decrease of hardness at room temperature. It was understood from those results that as the (meth)acrylate polymer, an isoalkyl (meth)acrylate polymer is preferred, and an isoalkyl methacrylate polymer is more preferred.

Furthermore, when a copolymer of isoalkyl (meth)acrylate and other (meth)acrylate was used as in Examples 13 to 16, the balance of wet grip performance/rolling resistance performance/low temperature performance/room temperature hardness was particularly excellent.

1. A rubber composition comprising: 100 parts by mass of a rubber component comprising diene rubber, and from 1 to 100 parts by mass of a (meth)acrylate polymer having a weight average molecular weight of from 5,000 to 1,000,000 and a glass transition point of from −70 to 0° C.

2. The rubber composition according to claim 1, wherein the (meth)acrylate polymer is an alkyl (meth)acrylate polymer having a repeating unit represented by the following general formula (1): 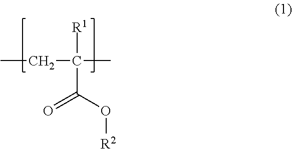
wherein R¹ is a hydrogen atom or a methyl group, R¹ present in the same molecule may be the same or different, R² is an alkyl group having from 4 to 18 carbon atoms, and R² present in the same molecule may be the same or different.

3. The rubber composition according to claim 2, wherein R² in the general formula (1) is represented by the following general formula (2): 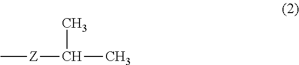
wherein Z is an alkylene group having from 1 to 15 carbon atoms, and Z in the same molecule may be the same or different.

4. The rubber composition according to claim 2, wherein the (meth)acrylate polymer is an alkyl (meth)acrylate polymer having
a repeating unit represented by the general formula (1) in which R² is represented by the following general formula (2), and
a repeating unit represented by the formula (1) in which R² is represented by the following general formula (3): 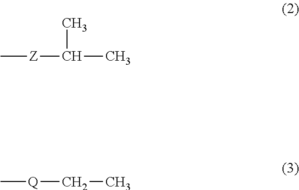
wherein Z is an alkylene group having from 1 to 15 carbon atoms, Z in the same molecule may be the same or different, Q is an alkylene group having from 2 to 16 carbon atoms, and Q in the same molecule may be the same or different.

5. The rubber composition according to claim 3, wherein Z in the general formula (2) is an alkylene group having from 5 to 15 carbon atoms.

6. The rubber composition according to claim 1, wherein the (meth)acrylate polymer is a (meth)acrylate polymer that does not have a reactive silyl group at the end thereof.

7. The rubber composition according to claim 1, wherein the (meth)acrylate polymer is a (meth)acrylate polymer having an end structure represented by the following general formula (4): 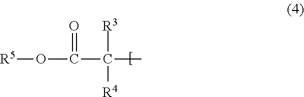
wherein R³ and R⁴ each independently are a hydrogen atom or an alkyl group having from 1 to 3 carbon atoms, but are not simultaneously a hydrogen atom, and R⁵ is a saturated or unsaturated alkyl group having from 2 to 20 carbon atoms.

8. The rubber composition according to claim 1, wherein the (meth)acrylate polymer is a (meth)acrylate polymer synthesized by radical polymerization using an initiator comprising an azo compound.

9. The rubber composition according to claim 1, wherein the (meth)acrylate polymer is a star polymer synthesized using a polyfunctional initiator.

10. The rubber composition according to claim 1, wherein the (meth)acrylate polymer is a polymer of a monomer comprising isodecyl methacrylate.

11. A pneumatic tire using the rubber composition according to claim 1.
